(19) United States
(12) Patent Application Publication
(10) Pub. No.: US 2008/0230187 A1
(43) Pub. Date: Sep. 25, 2008

(54) Lighted Valance

(76) Inventor: Daniel Caron, St-Janvier (CA)

Correspondence Address: INVENTION QUEBEC INC., 8065, Viau Blvd, Suite 202, Montreal, QC, H1R 2T2, CA

(21) Appl. No.: 12/076,561

(22) Filed: Mar. 20, 2008

(30) Foreign Application Priority Data
Mar. 21, 2007 (GB) 0705360.6

(51) Int. Cl. E06B 9/323

(52) U.S. Cl. 160/38

(57) ABSTRACT

A valance for concealing a headrail, the valance being usable with a light source, a first decorative insert and a second decorative insert, the second decorative insert having a different configuration than the first decorative insert. The valence includes: a headrail attachment bracket for attaching the valance to the headrail; a first compartment for receiving the light source thereinto, the first compartment being mechanically coupled to the headrail attachment bracket, the first compartment defining a window for allowing light emitted by the light source to exit from the first compartment; a second compartment, the second compartment being mechanically coupled to the first compartment with the first compartment located between the headrail attachment bracket and the second compartment; the second compartment including a second compartment housing and a removable panel, the second compartment housing defining a housing aperture and a panel attachment for attaching the removable panel thereto in a manner such that the removable panel extends substantially across the housing aperture; the removable panel defining a removable panel first side and an opposed removable panel second side, the removable panel first and second sides defining respectively a first side insert attachment for selectively attaching the first decorative insert thereto and a second side insert attachment for selectively attaching the second decorative insert thereto; the removable panel being removably attachable to the panel attachment for being used selectively in either one of a first orientation and a second orientation, wherein, in the first orientation, the removable panel first side faces outwardly and the second side insert attachment operatively engages the panel attachment for attaching the removable panel thereto and, in the second orientation, the removable panel second side faces outwardly and the first side insert attachment operatively engages the panel attachment for attaching the removable panel thereto.

### FIELD OF THE INVENTION

The present invention relates generally to valances for concealing the headrail of vertical blinds, curtains or the like, and, more particularly, to lighted valances for providing decorative lighting on the blinds and immediate surroundings of the headrail.

### BACKGROUND OF THE INVENTION

Lighted valances are known in the art and are used primarily to conceal the headrail of vertical blinds, draperies, curtains or the like, as well as providing decorative lighting effects on the surface of the latter. These prior art devices usually consist of an elongated housing which can be mounted on, or be an integral part of, the headrail assembly, with a light source disposed internally along the width of the housing for illuminating the surface of the blind and/or the immediate surroundings of the headrail through suitable openings on the bottom and top ends of the housing. The elongated housing is generally made of opaque materials, such as extruded aluminum or plastic, or of light diffusing material, allowing the internal light source to emanate from the top and bottom of the housing, as well as through the peripheral walls of the device. The light source integrated in the lighted valances generally consists of one or more fluorescent tubes or low-voltage incandescent light bulbs.

While these prior art devices can generally fulfill the main objective of providing decorative lighting effects emanating from a valance, they also offer at least one or more of the following disadvantages:

a) they are generally designed around a custom headrail system and support brackets, which involve removing the ones in place when retrofitting existing conventional blinds or the like, with a lighted valance;

b) they are generally compatible with only one type of decorative add-on linings for covering the peripheral walls of the valance, such as a popular system consisting of decorative inserts that are slid between tracks provided along the top and bottom edges of the walls, or an alternate popular system which consists of more broad, clip-on linings that completely cover the peripheral walls;

c) lighted valance using fluorescent tubes as a light source are usually bulky and heavy due to the ballast unit that usually integrated within the valance. Furthermore, fluorescent tubes are generally available only in standard lengths;

d) when the light source consists of incandescent lamps or strips of LEDs, the resulting lighting effect is generally non-uniform throughout the lighted valance, unless heavy-gauge light diffusing materials are used, which substantially dims the intensity of the emitted light. In the case of fluorescent tubes, the latter generally leave the end limits of the peripheral walls unlighted due to the minimum space required by the end sockets;

e) fluorescent tubes and incandescent lamps generally have a limited longevity, which implies routine maintenance and replacement costs;

f) fluorescent light tubes, incandescent lamps and selected high-intensity LEDs can represent a non-negligible power consumption, as well as a potential fire hazard.

Against this background, there exists a need for a new and improved valance. It is a general object of the present invention to provide such a valance.

### SUMMARY OF THE INVENTION

In a first broad aspect, the invention provides a valance for concealing a headrail, the valance being usable with a light source, a first decorative insert and a second decorative insert, the second decorative insert having a different configuration than the first decorative insert. The valence includes:

a headrail attachment bracket for attaching the valance to the headrail;

a first compartment for receiving the light source thereinto, the first compartment being mechanically coupled to the headrail attachment bracket, the first compartment defining a window for allowing light emitted by the light source to exit from the first compartment;

a second compartment, the second compartment being mechanically coupled to the first compartment with the first compartment located between the headrail attachment bracket and the second compartment;

the second compartment including a second compartment housing and a removable panel, the second compartment housing defining a housing aperture and a panel attachment for attaching the removable panel thereto in a manner such that the removable panel extends substantially across the housing aperture;

the removable panel defining a removable panel first side and an opposed removable panel second side, the removable panel first and second sides defining respectively a first side insert attachment for selectively attaching the first decorative insert thereto and a second side insert attachment for selectively attaching the second decorative insert thereto;

the removable panel being removably attachable to the panel attachment for being used selectively in either one of a first orientation and a second orientation, wherein, in the first orientation, the removable panel first side faces outwardly and the second side insert attachment operatively engages the panel attachment for attaching the removable panel thereto and, in the second orientation, the removable panel second side faces outwardly and the first side insert attachment operatively engages the panel attachment for attaching the removable panel thereto.

In another broad aspect, the invention provides a valance further comprising the light source provided in the first compartment.

In some embodiments of the present invention, the valance generally consists of a horizontally elongated housing adapted to be removably fixed along the longitudinal front portion of a conventional headrail. Perpendicular lateral end walls terminate each side ends of the elongated housing and are extending toward the bearing wall at the back of the headrail, thus creating a three-sided peripheral wall for concealing the headrail. Furthermore, the horizontal housing generally spans the width of the headrail and is composed of the second compartment, having a substantially upright rectangular cross-section, that is rigidly juxtaposed to the first compartment that extends generally parallel to the second compartment and which is of equal width, but having a relatively smaller cross-section as well as representing the linking intermediate position between the second compartment and the headrail attachment, which is usable for removably fastening the valance to the headrail.

The second compartment is typically used for housing a relatively small and compact solid state, high voltage power supply for cold-cathode (gas discharge) lighting applications, while the first compartment is for longitudinally housing therein an associated neon tube having electrodes at each end. The power supply is operatively coupled to the light source for providing electrical power thereto. In alternative embodiments of the invention, the first compartment is used for receiving a strip including a plurality of substantially longitudinally spaced apart solid-state light emitting elements. In these embodiments, the power supply is typically relatively small and can be located substantially adjacent the conventional electrical plug used to connect the power supply to main current.

The second compartment is typically made of an extruded opaque material, such as plastic, while the first compartment has its top and bottom walls made of a transparent material, such as, for example, transparent plastic or acrylic glass (e.g. Plexiglas), for allowing the light emitted by the light source to project upwardly toward the ceiling, as well as downwardly towards the upper portion of the depending curtain or blinds under the headrail. The top and bottom walls therefore create windows in the first compartment. Furthermore, in some embodiments of the invention, a light altering insert can be slidably inserted between slots each extending along longitudinal sides of the translucent top wall of the first compartment.

An advantage of the proposed valance resides in that by choosing the appropriate orientation of the removable panel, the latter becomes compatible with two of the commercially available configurations of decorative inserts for valances.

Advantageously, in some embodiments of the invention, the proposed invention also provides a valance:

a) which is compatible with most commercially available headrails and, hence, avoid the grueling task of removing the existing one when retrofitting, for example, a vertical blind with a lighted valance;

b) whose reversible removable panel allows the fastening of decorative inserts in the form of two of the most commercially available decorative linings for valances;

c) whose compact power supply and neon tube allows for, as well, compact and light valance assemblies that are relatively easy to manipulate during installation;

d) which inherently offers a substantially uniform lighting source throughout the full width of the valance;

e) whose neon/solid state light emitting element based lighting system has an extended longevity, typically 20 years or more, and, hence, substantially reduce long term maintenance and replacement costs;

f) whose neon/solid state light emitting element based lighting system has a relatively low power consumption, and, hence, substantially reduce long term operating costs, as well as fire hazards since its low power consumption results in an overall low heat emission;

g) which is relatively easily installed on a headrail and is relatively economical to produce.

Other objects, advantages and features of the present invention will become more apparent upon reading of the following non-restrictive description of preferred embodiments thereof, given by way of example only with reference to the accompanying drawings.

### BRIEF DESCRIPTION OF THE DRAWINGS

In the drawings, closely related parts have the same reference number but different alphabetic suffixes. In the drawings,

FIG. 1: is an environmental perspective view of a valance in accordance with an embodiment of the present invention, here shown mounted on a conventional headrail with vertical blinds;

FIG. 2: is a top plan, partial cross-sectional view of the valance of. FIG. 1;

FIG. 3: is a perspective, partial cross-sectional view of the valance of FIG. 1, shown mounted on a conventional headrail;

FIG. 4: is a side cross-sectional view of the valance of FIG. 1, shown mounted on a conventional headrail;

FIG. 5: is a perspective, partial cross-sectional view of a valance in accordance with an alternative embodiment of the present invention, shown mounted on a conventional headrail;

FIG. 6: is a partial perspective view of a strip including solid-state light emitting elements usable with the valance shown in FIG. 5; and

FIG. 7: is a partial side cross-sectional view of the valance of FIG. 5;

### DETAILED DESCRIPTION

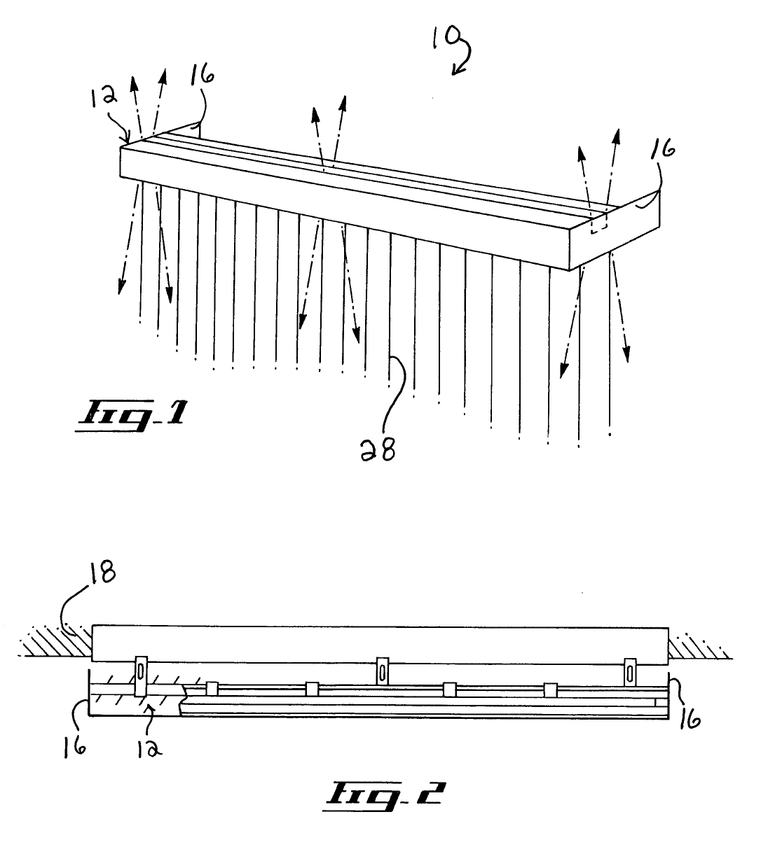

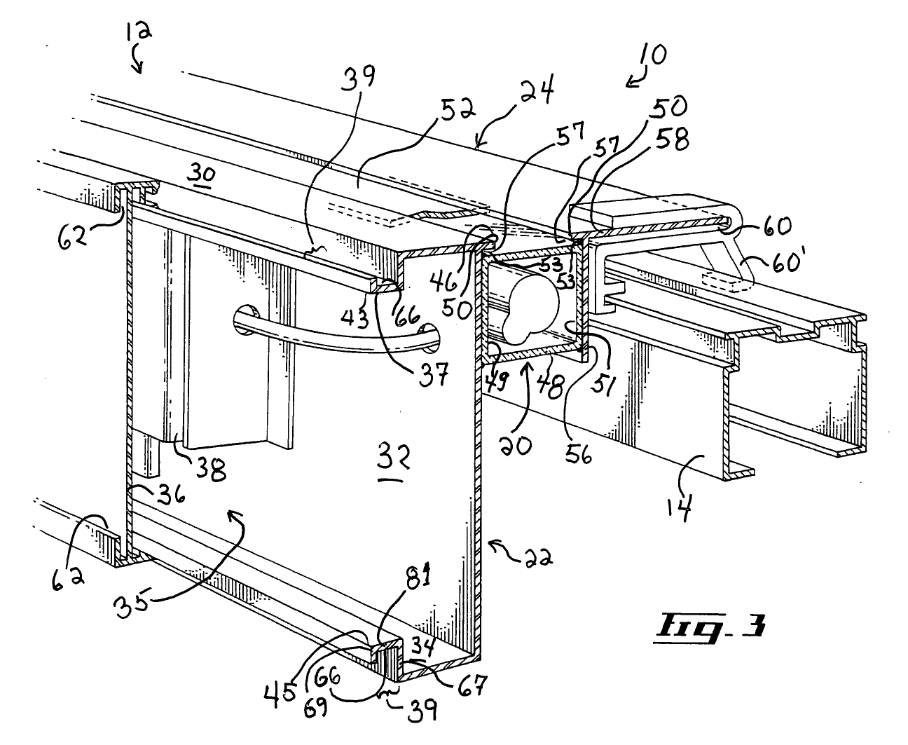

FIGS. 1 to 4 show various aspects of an embodiment of a valance 10 usable for concealing a headrail 14 having dependent mechanism and vertical blinds 28 (as best shown in FIG. 4) in accordance with an embodiment of the present invention. As best illustrated in FIG. 1, the valance 10 generally consists of an horizontally elongated main housing 12 which substantially extends the width of a headrail 14 and is terminated at each lateral ends with end walls 16 that are perpendicularly projecting towards a bearing wall 18 (as best shown in FIG. 2). The headrail 14 is affixed to the bearing wall 18 using conventional hooks 15, as shown in FIG. 4. The reader skilled in the art will readily appreciate that directional terminology, such as “up” and “top”, among others, is used in the present document to facilitate the description of the valance 10 and refers to a valance 10 mounted in a conventional orientation to the headrail 14. However, this directional terminology is used for clarity purposes only and should not be used to restrict the scope of the appended claims.

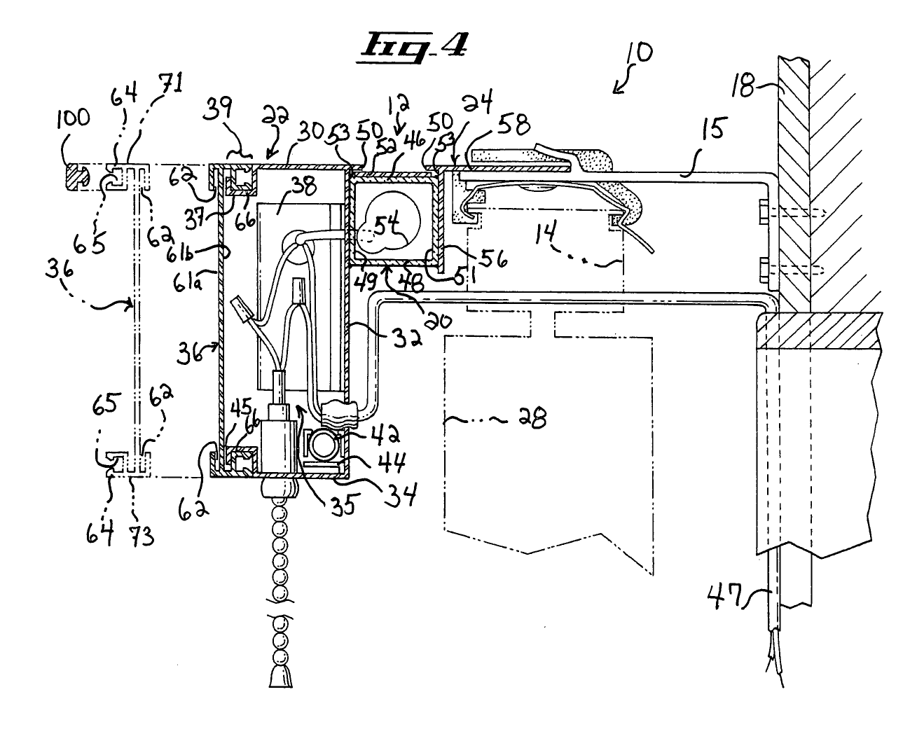

As better seen in FIGS. 3 and 4, the main housing 12 is divided into first and second compartments 20 and 22 that are extending substantially parallel to each other along the longitudinal axis of the main housing 12, with the rear end of first compartment 20 being appended with a headrail attachment bracket 24 for attaching the valance 10 to the headrail 14. In other words, the first compartment 20 is mechanically coupled to the headrail attachment bracket 24 and the second compartment 22 is mechanically coupled to the first compartment 20 with the first compartment 20 located between the headrail attachment bracket 24 and the second compartment 22. The outer ends of main housing 12 are typically left open for allowing the lateral insertion of decorative inserts (described in more details hereinafter), prior to assembling lateral end walls 16 on the valance 10. Also, the second compartment 22 and headrail attachment bracket 24 can be transparent or opaque, but are typically opaque.

As better shown in FIG. 4, the second compartment 22 has a substantially upright rectangular cross-section with a roughly equivalent height dimension as the front ends of conventional valances, and is generally defined as having a second compartment top wall 30, a second compartment rear wall 32, a second compartment bottom wall 34 and a removable panel 36 (described in more details hereinafter).

The second compartment top, rear and bottom walls 30, 32 and 34 together form a second compartment housing 35. A housing aperture 37 extends between the second compartment top and bottom walls 30 and 34 and defines a pair of opposed and substantially longitudinally extending housing aperture longitudinal edges 43 and 45. The second compartment housing also defines a panel attachment 39 for attaching the removable panel 36 thereto in a manner such that the removable panel 36 extends substantially across the housing aperture 37. While typically the housing aperture 37 is located substantially opposed to the headrail attachment bracket 24 to provide a convenient and aesthetic location for the decorative inserts, other configurations of the housing aperture 37 are also within the scope of the present invention.

The panel attachment 39 includes a pair of substantially longitudinally extending retaining channels 66. The retaining channels 66 each extend along a respective one of the housing aperture longitudinal edges 43 and 45. As seen in FIG. 3, Each retaining channel 66 is defined by a panel attachment proximalmost segment 67, a panel attachment distalmost segment 69 extending substantially parallel to the panel attachment proximalmost segment 67 and a panel attachment spacing segment 81 extending between the panel attachment proximalmost and distalmost segments 67 and 69. In a specific embodiment of the invention, the panel attachment proximalmost and distalmost segments 67 and 69 extend substantially vertically and the panel attachment spacing segment 81 extends substantially horizontally substantially adjacent the housing aperture 37. In this embodiment, the retaining channels 66 are outwardly open relative to the housing aperture 37, which facilitates attachment to and removal from the panel attachment 39 of the removable panel 36.

Referring to FIG. 3, the second compartment 22 typically houses a power supply, for example a compact solid state, high-voltage power supply 38 for cold-cathode lighting applications that can be rigidly fixed, for example, to one side end of the second compartment rear wall 32 using any suitable means such as screws or glue (not shown in the drawings), and with one of the two high-voltage output wires 42 inserted along an inner right-angle flange 44 for reaching the opposite end of the compartment. The power supply 38 is operatively coupled to the light source, and more specifically to a neon tube 54, for providing electrical power thereto.

The first compartment 20 is generally defined by a first compartment top wall 46, a first compartment bottom wall 48 located substantially opposed to the first compartment top wall 46, a first compartment front wall 49 extending between the first compartment top and bottom walls 46 and 48 and a first compartment rear wall 51 located substantially opposed to the first compartment front wall 49 and also extending between the first compartment top and bottom walls 46 and 48.

In some embodiments of the invention, the first compartment top and bottom walls 46 and 48 define windows in the first compartment 20 and are transparent or translucent. Also, in some embodiments of the invention, the first compartment top and bottom walls 46 and 48 can have magnifying glass properties for better directing light emitting from the neon tube 54 encased therein. Typically, the first compartment front and rear walls 49 and 51 are substantially opaque. Advantageously, the first compartment 20 is manufacturable by being extruded as a single piece of material, without requiring assembly of panels made out of different materials. In alternative embodiments of the invention, windows are defined by having suitable positioned aperture in the first compartment 20.

The first compartment front wall 49 is secured to the second compartment rear wall 32 and the first compartment rear wall 51 is secured to the headrail attachment bracket 24. For example, glue is used to secure the first compartment 20 to the second compartment 22 and to the headrail attachment bracket 24.

The first compartment 20 is used for housing a light source in the form of a neon tube 54 throughout its length, with conventional power connections provided at each ends of the latter (not shown). Neon tube 54 can be of any suitable color which, in cooperative relation with first compartment top and bottom walls 46 and 48, as well as light altering insert 52, described in further details hereinbelow, provides decorative lighting, or “accent lighting”, projected upwardly towards the ceiling and/or downwardly towards the curtains or vertical blinds 28 underlying the headrail 14. The power cord 47, for powering the light source, can be run through the bearing wall 18 to which the headrail 14 is attached, or be concealed behind one of the vertical blinds 28 or curtain, depending on the application.

The window defined by the first compartment top wall 46 defines a pair of substantially opposed window sides 53. The first compartment 20 typically has a relatively smaller cross-section than the second compartment 22 and has a slightly recessed first compartment top wall 46 which, concurrently with side protuberances 50 overhanging over the first compartment top wall 46, define substantially parallel an inwardly opening first compartment slots 57 between which the light altering insert 52 can be slid in place from one end of main housing 12. The first compartment slots 57 each extend along a respective one of the longitudinal window sides 53 and together form a light altering insert attachment for removably attaching the light altering insert 52 thereto in a manner such that the light altering insert extends substantially across the window defined by the first compartment top wall 46.

Examples of light altering inserts 52 include light altering insert is selected from the group consisting of a substantially opaque insert, a substantially transparent insert, a substantially translucent insert, a tainted substantially transparent insert, a reflecting insert for reflecting light emitted by the light source and a lens insert for modifying the spatial distribution outside of the first compartment 20 of the light emitted by the light source.

The headrail attachment bracket 24 is generally defined by a right-angled flange having a vertical portion 56 and a horizontal portion 58 projecting rearwardly from the rear top edge of the first compartment 20. Horizontal portion 58 serves as an attachment means with the supporting headrail 14 through a compatible conventional receiving open channel 60 of a conventional hook 60′ generally positioned on top of the headrail 14 (as best shown in FIG. 3). It is to be understood that horizontal portion 58 can be of any other compatible configuration for allowing valance 10 to be removably attached to a given headrail configuration.

The removable panel 36 defines a removable panel first side 61a and an opposed removable panel second side 61b. The removable panel first and second sides 61a and 61b define respectively a first side insert attachment for selectively attaching a first decorative insert thereto and a second side insert attachment for selectively attaching a second decorative insert thereto. The first and second decorative inserts differ from each other. The removable panel 36 is removably attachable to the panel attachment 39 for being used selectively in either one of a first orientation and a second orientation. In the first orientation, shown in full lines in FIG. 4, the removable panel first side 61a faces outwardly and the second side insert attachment operatively engages the panel attachment 39 for attaching the removable panel 36 thereto. In the second orientation, shown in phantom lines in FIG. 4, the removable panel second side 61b faces outwardly and the first side insert attachment operatively engages the panel attachment 39 for attaching the removable panel 36 thereto. The first and second side insert attachments are both substantially longitudinally slidably mountable to the retaining channels 66 for attaching the removable panel 36 to the second compartment housing 35.

In a specific embodiment of the invention, the first side insert attachment defines a pair of substantially longitudinally extending and inwardly open receiving attachment channels 62, the receiving attachment channels being in a substantially laterally spaced apart relationship relatively to each other. For example, the receiving attachment channels 62 are longitudinally extending along the upper and lower edges 71 and 73 of the removable panel 36.

When the removable panel 36 is in the first orientation, a first decorative insert (not shown in the drawings) having a substantially plate-shaped configuration is insertable between the receiving attachment channels 62. When the removable panel 36 is in the second orientation, the panel attachment distalmost segments 69, better seen in FIG. 3, are each being substantially snugly receivable inside a respective one of the receiving attachment channels 62.

Returning to FIG. 4, the second side insert attachment includes a pair of protuberances 64 each extending substantially longitudinally in a substantially laterally spaced apart relationship relative to each other. For example, the protuberances 64 have a substantially Y-shaped cross-sectional configuration in a plane extending substantially perpendicularly to the longitudinal axis of the main housing 12. Typically, the protuberances 64 are also longitudinally extending along the upper and lower edges 71 and 73 of the removable panel 36. The protuberances 64 defines an insert receiving groove 65 extending substantially longitudinally for slidably receiving at least a portion of a second decorative insert 100 thereinto. For example, the second decorative insert 100 has a substantially H-shaped cross-sectional configuration and the rearmost portion thereof is receivable within the insert receiving groove 65.

When the removable panel 36 is in the second orientation, the second decorative insert 100 is insertable in the insert receiving groove 65. When the removable panel 36 is in the first orientation, the protuberances 64 are each substantially snugly receivable inside a respective one of the retaining channels 66.

These configurations of the first and second side insert attachments provides for a relatively stable and strong attachment of the removable panel 36 to the panel attachment 39 in both the first and second orientations.

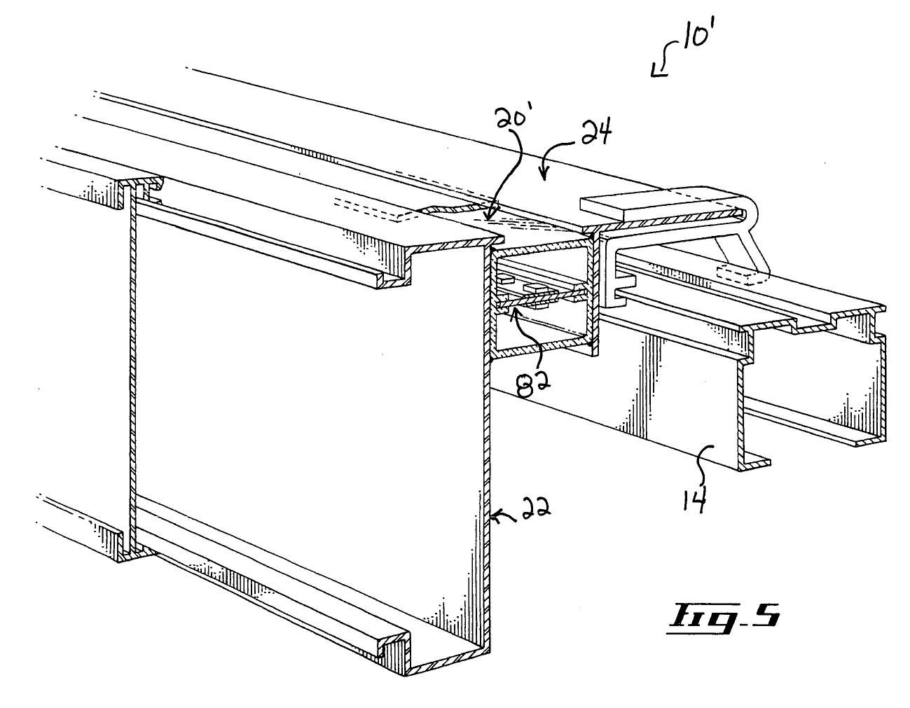

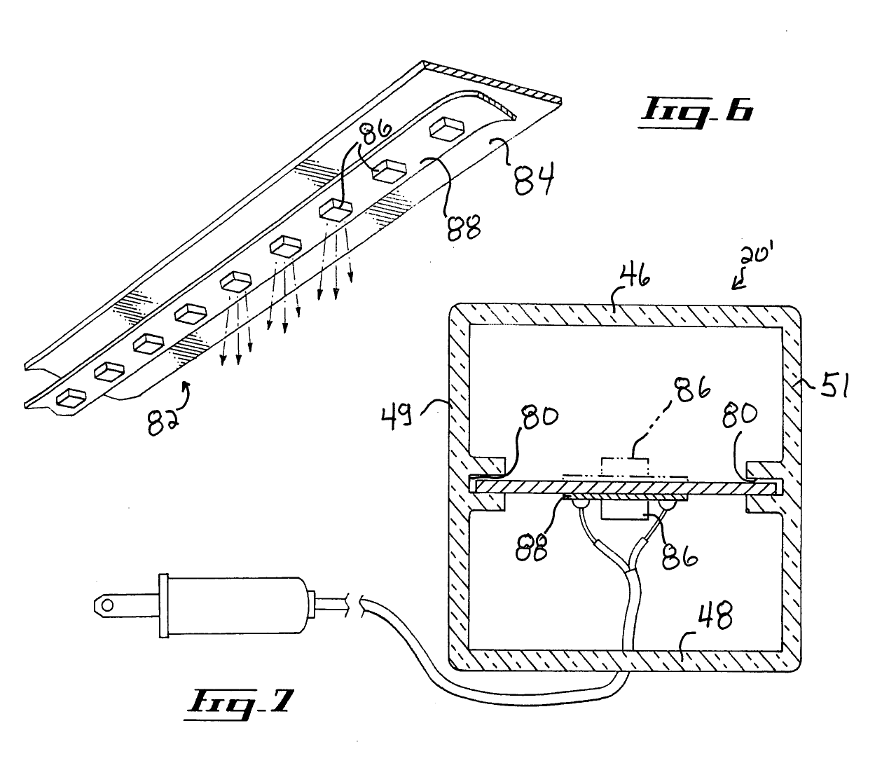

FIGS. 5 to 7 illustrate a valance 10′ in accordance with an alternative embodiment of the present invention. The valance 10′ is similar to the valance 10 except for the use of an alternative light source and an alternative first compartment 20′. As better seen in FIG. 7, in the valance 10′, support grooves 80 are formed in the first compartment front and rear walls 49 and 51, both support grooves extending substantially inwardly. Typically, the support grooves 80 are located midway between the first compartment top and bottom walls 46 and 48.

The light sourced includes a strip 82. The strip 82 includes a substantially panel-shaped backing 84 to which a plurality of substantially longitudinally spaced apart solid-state light emitting elements 86 are mounted, either on one or two sides of the backing 84, for example using an adhesive band 88. For example, the longitudinally spaced apart solid-state light emitting elements 8.6 are light emitting diodes (LEDs). In this embodiment, the power supply 38′ may be relatively compact and therefore need not be positioned within the first compartment 20.

Although the present invention has been described hereinabove by way of preferred embodiments thereof, it can be modified, without departing from the spirit and nature of the subject invention as defined in the appended claims.

What is claimed is:

1. A valance for concealing a headrail, said valance being usable with a light source, a first decorative insert and a second decorative insert, said second decorative insert having a different configuration than said first decorative insert, said valence comprising:
a headrail attachment bracket for attaching said valance to said headrail;
a first compartment for receiving said light source thereinto, said first compartment being mechanically coupled to said headrail attachment bracket, said first compartment defining a window for allowing light emitted by said light source to exit from said first compartment;
a second compartment, said second compartment being mechanically coupled to said first compartment with said first compartment located between said headrail attachment bracket and said second compartment;
said second compartment including a second compartment housing and a removable panel, said second compartment housing defining a housing aperture and a panel attachment for attaching said removable panel thereto in a manner such that said removable panel extends substantially across said housing aperture;
said removable panel defining a removable panel first side and an opposed removable panel second side, said removable panel first and second sides defining respectively a first side insert attachment for selectively attaching said first decorative insert thereto and a second side insert attachment for selectively attaching said second decorative insert thereto;
said removable panel being removably attachable to said panel attachment for being used selectively in either one of a first orientation and a second orientation, wherein, in said first orientation, said removable panel first side faces outwardly and said second side insert attachment operatively engages said panel attachment for attaching said removable panel thereto and, in said second orientation, said removable panel second side faces outwardly and said first side insert attachment operatively engages said panel attachment for attaching said removable panel thereto.

2. A valance as defined in claim 1, wherein
said second compartment is substantially elongated and defines a longitudinal axis;
said housing aperture defines a pair of opposed and substantially longitudinally extending housing aperture longitudinal edges;
said panel attachment includes a pair of substantially longitudinally extending retaining channels, said retaining channels each extending along a respective one of said housing aperture longitudinal edges.

3. A valance as defined in claim 2, wherein said first and second side insert attachments are both substantially longitudinally slidably mountable to said retaining channels for attaching said removable panel to said second compartment housing.

4. A valance as defined in claim 2, wherein said retaining channels are outwardly open relative to said housing aperture.

5. A valance as defined in claim 2, wherein said first side insert attachment defines a pair of substantially longitudinally extending and inwardly open receiving attachment channels, said receiving attachment channels being in a substantially laterally spaced apart relationship relatively to each other.

6. A valance as defined in claim 5, wherein said panel attachment includes a pair of panel attachment distalmost segments extending each along a respective one of said housing aperture longitudinal edges, said panel attachment distalmost segments each being substantially snugly receivable inside a respective one of said receiving attachment channels.

7. A valance as defined in claim 2, wherein said second side insert attachment includes a pair of protuberances each extending substantially longitudinally, said protuberances being in a substantially laterally spaced apart relationship relative to each other.

8. A valance as defined in claim 7, wherein said protuberances each have a substantially Y-shaped cross-sectional configuration in a plane extending substantially perpendicularly to said longitudinal axis.

9. A valance as defined in claim 7, wherein said protuberances are configured and sized so as to be substantially snugly receivable in said retaining channel.

10. A valance as defined in claim 7, wherein at least one of said protuberances defines an insert receiving groove extending substantially longitudinally for slidably receiving at least a portion of said second decorative insert thereinto.

11. A valance as defined in claim 1, wherein said first compartment defines a pair of substantially opposed windows.

12. A valance as defined in claim 1, wherein said housing aperture is located substantially opposed to said attachment bracket.

13. A valance as defined in claim 1, wherein
said valance is usable with a light altering insert; and
said first compartment includes a light altering insert attachment for removably attaching said light altering insert thereto in a manner such that said light altering insert extends substantially across said window.

14. A valance as defined in claim 13, wherein said light altering insert is selected from the group consisting of a substantially opaque insert, a substantially transparent insert, a substantially translucent insert, a tainted substantially transparent insert, a reflecting insert and a lens insert.

15. A valance as defined in claim 13, wherein
said window defines a pair of substantially opposed window sides; and
said first compartment defines a pair of substantially parallel an inwardly opening first compartment slots each extending along a respective one of said opposed longitudinal window sides;
said light altering insert being slidably insertable between said first compartment slots.

16. A valance for concealing a headrail, said valance being usable with a first decorative insert and a second decorative insert, said second decorative insert having a different configuration than said first decorative insert, said valence comprising:
a headrail attachment bracket for attaching said valance to said headrail;
a first compartment, said first compartment being mechanically coupled to said headrail attachment bracket, said first compartment defining a window;
a second compartment, said second compartment being mechanically coupled to said first compartment with said first compartment located between said headrail attachment bracket and said second compartment; and
a light source provided in said first compartment;
said second compartment including a second compartment housing and a removable panel, said second compartment housing defining a housing aperture and a panel attachment for attaching said removable panel thereto in a manner such that said removable panel extends substantially across said housing aperture;
said removable panel defining a removable panel first side and an opposed removable panel second side, said removable panel first and second sides defining respectively a first side insert attachment for selectively attaching said first decorative insert thereto and a second side insert attachment for selectively attaching said second decorative insert thereto;
said removable panel being removably attachable to said panel attachment for being used selectively in either one of a first orientation and a second orientation, wherein, in said first orientation, said removable panel first side faces outwardly and said second side insert attachment operatively engages said panel attachment for attaching said removable panel thereto and, in said second orientation, said removable panel second side faces outwardly and said first side insert attachment operatively engages said panel attachment for attaching said removable panel thereto.

17. A valance as defined in claim 16, said valance further comprising a power supply operatively coupled to said light source for providing electrical power to said light source.

18. A valance as defined in claim 17, wherein said power supply is located inside said second compartment.

19. A valance as defined in claim 16, wherein said light sourced includes a strip including a plurality of substantially longitudinally spaced apart solid-state light emitting elements.
